(19) United States
(12) Patent Application Publication
(10) Pub. No.: US 2026/0258837 A1
(43) Pub. Date: Sep. 3, 2026

(54) Electric motor

(71) Applicant: IGARASHI MOTOREN GmbH, Burgthann-Ezelsdorf (DE)

(72) Inventor: Andreas KUTSCH, Nürnberg (DE)

(21) Appl. No.: 19/548,207

(22) Filed: Feb. 24, 2026

(30) Foreign Application Priority Data
Feb. 28, 2025 (DE) 10 2025 107 690.1
Aug. 6, 2025 (DE) 10 2025 131 265.6

(51) Int. Cl. F16C 25/08; H02K 5/16

(52) U.S. Cl. CPC F16C 25/083; H02K 5/161; F16C 2380/26

(57) ABSTRACT

Please delete the abstract in its entirety and substitute therefor the abstract below. An electric motor comprises a tubular housing with end face covers, respectively one rotary bearing held on the end face covers, a motor shaft which has an axis of rotation and is mounted in the rotary bearings so as to rotate with respect to its axis of rotation, and a spring element for applying a spring force to the motor shaft, wherein the spring force has a force component in the radial direction with respect to the axis of rotation.

The present patent application claims the priorities of the German patent applications DE 10 2025 107 690.1 and DE 10 2025 131 265.6, the con-tents of which are incorporated herein by reference.

The invention relates to an electric motor.

Electric motors are used, for example, in spindle drives to carry out flap adjustment. Such a flap is, for example, a tailgate in an automobile. It has been found that unwanted noise issues can occur when adjusting the flap. The object of the invention is to minimise the noise generated by electrically operated flap adjustment.

This object is achieved according to the invention by an electric motor having the features set out in claim 1, by a spindle drive having the features set out in claim 12 and by a flap arrangement having the features set out in claim 13.

It has been recognised that the clearance present between the motor shaft and rotary bearing in an electric motor, which is also referred to as bearing clearance and can be a few um, may result in an undefined load state in particular in an unloaded state of the motor shaft, such that rotational irregularity may build up and cause vibrations when the motor shaft is actuated. These vibrations, which in particular depend on the installation state of the electric motor, in particular of a spindle drive, may cause disturbing noise. According to the invention, it has been found that a defined load state can be produced by a radial spring force being applied to the motor shaft by means of a spring element. Undefined vibrations of the motor shaft and noise caused thereby are avoided. The electric motor is suitable in particular for use in a spindle drive and in particular for a flap arrangement.

The electric motor has a tubular housing. The housing has a housing longitudinal axis. The housing is in particular substantially cylindrical. The housing has end face covers. The end face covers can be formed integrally with the housing and/or respectively connected to the housing as a separate element. A rotary bearing is respectively held on the end face covers, in which the motor shaft is mounted so as to rotate about its axis of rotation. The spring element is made in particular from a plastic material, in particular from thermoplastic material, in particular from polyether ether ketone (PEEK).

The spring element is in particular disc-like. The spring element is in particular planar in design, in particular designed as a flat disc. The spring element is designed to provide a spring force, which is oriented in a plane pre-determined by the spring element. The spring force is in particular oriented transversely and in particular perpendicular to the axis of rotation of the motor shaft.

An electric motor according to claim 2 is robust, i.e. stable, and space-saving An electric motor according to claim 3 enables the spring force to be advantageously applied to the motor shaft. This is in particular based on the fact that a gear unit can be coupled to the output of the motor shaft, which results in the motor shaft being arranged substantially load-free in the output-side rotary bearing. This load-free condition can cause an undefined state in the rotary bearing, resulting in undesired noise. This is prevented with the corresponding arrangement of the spring element.

The design of the spring element according to claim 4 is compact and durable. The design of the spring element as a spring washer made of a plastic material is cost-efficient.

Attachment of the spring washer according to claim 5 is particularly gentle on the material. The spring washer is reliably received on the rotary bearing and held thereon. Mechanical stress on the spring washer resulting from its installation on the rotary bearing is minimised.

Alternatively, the spring washer according to claim 6 can also be arranged along the axis of rotation adjacent to the rotary bearing. In particular, the spring washer is arranged on the end face of an end surface of the rotary bearing. The end surface of the rotary bearing is in particular planar, in particular free of protrusions and in particular designed without an end face recess. The spring washer is axially supported over a large area and reliably on the rotary bearing. The rotary bearing itself can be designed in a straight-forward manner, in particular as a disc, and can in particular be a standard component. The installation of the spring washer on the rotary bearing has been simplified. The risk of unwanted acoustic abnormalities is reduced.

The design of the spring washer according to claim 7 guarantees a defined radial offset. An in particular permanent, elastic spring force is exerted on the motor shaft by means of the spring element. The spring washer has an outer contour having an outer contour centre point. The outer contour is in particular circular. The spring washer further has an inner contour having an inner contour centre point. The inner contour is in particular mostly circular. A radial distance between the centre points arranged in a plane oriented perpendicular to the axis of rotation is at least 1% of the diameter of the motor shaft, in particular at least 2%, in particular at least 3%, in particular at least 4% and in particular at least 4.5%. In particular, the distance of the centre points from one another is no more than 7.5%, in particular no more than 6% and in particular no more than 5%. The radial distance between the centre points is in particular at least 0.05 mm, in particular 0.1 mm and in particular 0.15 mm. The radial distance is in particular no more than 0.25 mm, in particular no more than 0.20 mm and in particular no more than 0.15 mm.

The design of the spring washer with at least one spring arm according to claim 8 enables force to be advantageously applied to the motor shaft. The at least one spring arm is in particular elastic and acts in the radial direction with respect to the axis of rotation of the motor shaft. The spring arm has an arm width oriented in the radial direction with respect to the axis of rotation, which is at least 5%, in particular at least 10%, in particular at least 15% and in particular at least 17.5% of the diameter of the outer contour of the spring washer. The arm width is comparatively large and enables robust application of force from the spring arm to the motor shaft. The at least one spring arm has a spring arm length, which extends along the circumferential direction around the axis of rotation. The spring arm length is in particular at least 20°, in particular at least 30°, in particular at least 45°, in particular at least 60°, in particular at least 65°, and in particular at least 70° in relation to a circumferential direction around the axis of rotation of the motor shaft. This ensures in particular that the spring washer withstands a sufficient number of cycles such that the overall service life of the electric motor is not limited by the use of the spring washer. The electric motor is designed to be mechanically robust. It is particularly advantageous for the at least one spring arm to have a free spring arm end.

An electric motor according to claim 9 ensues that spring force is advantageously applied to the motor shaft.

An electric motor according to claim 10 simplifies the application of the spring-loaded restoring force. Elastic deflection of the spring arm is simplified by virtue of the fact that a relief recess is arranged on the rear side of the spring arm.

A spring washer with two spring arms according to claim 11 has proven particularly advantageous in terms of spring force application. In particular, it is thereby possible to apply a centring and symmetrically acting spring force to the motor shaft. The occurrence of annoying engine noise is also reduced.

A spindle drive according to claim 12 has substantially the advantages of the electric motor, to which reference is hereby made.

A flap arrangement according to claim 13 has substantially the advantages of the spindle drive.

Both the features specified in the claims and the features specified in the following exemplary embodiments of the electric motor according to the invention are respectively suitable, either on their own or in combination with one another, for developing the object according to the invention further. The respective combinations of features do not constitute any re-striction with regard to the embodiments of the subject matter of the invention, but are substantially merely exemplary in nature.

Further advantageous embodiments, additional features and details of the invention result from the following description of exemplary embodiments based on the drawing. In the drawing:

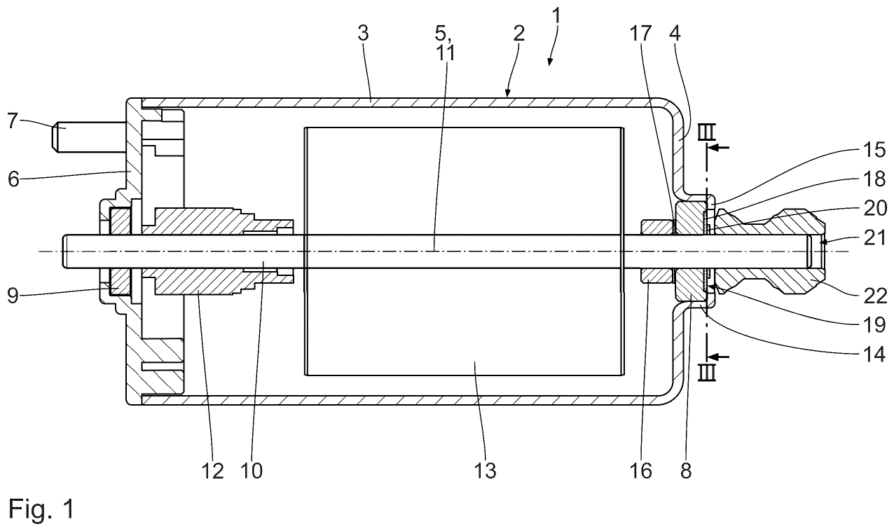

FIG. 1 shows a longitudinal section through an electric motor according to the invention,

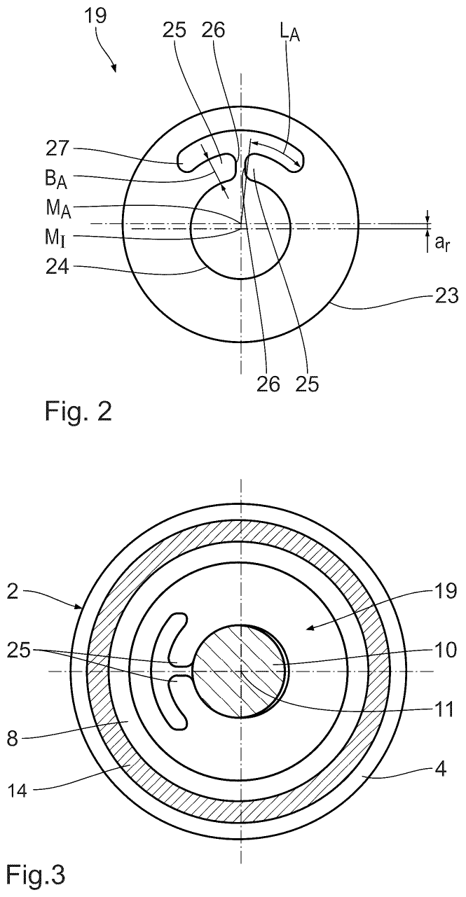

FIG. 2 shows an enlarged plan view of a spring element of the electric motor according to FIG. 1 designed as a spring washer,

FIG. 3 shows a sectional view along section line III-III in FIG. 1,

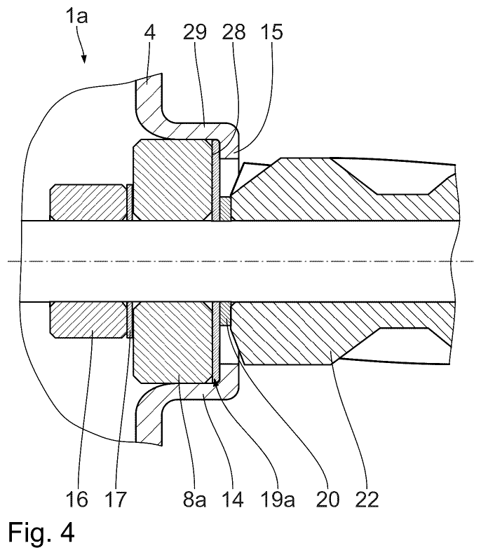

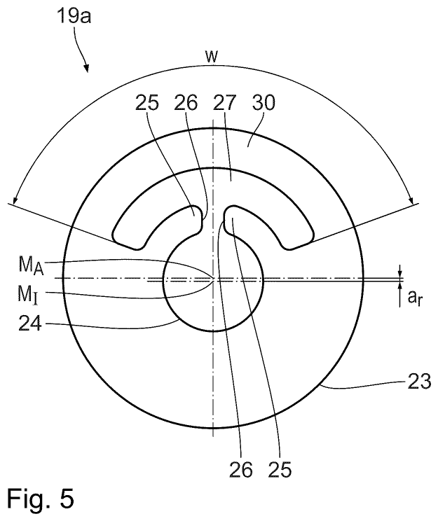

FIG. 4 shows an enlarged longitudinal sectional illustration in accordance with FIG. 1 according to another exemplary embodiment, in which the spring washer is arranged adjacent to the rotary bearing,

FIG. 5 shows a view of the spring washer according to FIG. 4, corresponding to FIG. 2.

An electric motor 1 shown in FIG. 1 is designed in particular to actuate a spindle drive, in particular for adjusting a flap of a flap arrangement. Such a flap arrangement has in particular a housing and a flap which can be adjusted in relation to the housing. A flap arrangement is in particular a motor vehicle with a tailgate.

The electric motor 1 comprises a housing 2, which is designed as a housing base body 4 with an integrally formed end face cover 4 according to the exemplary embodiment shown. The housing 2 is substantially hollow-cylindrical. The housing 2 is tubular. The housing 2 has a housing longitudinal axis 5.

The housing base body 3 is designed with an opening at the end opposite the integrally formed end face cover 4. This opening is closed by means of another end face cover 6, which is placed over the opening and attached to the housing base body 3. The end face cover 6 is designed to be separate from the housing 2 and is fixedly connected to the housing 2. An electrical connection 7 is arranged on the end face cover 7.

A rotary bearing 8, 9 is respectively arranged on the two end face covers 4, 6. The two rotary bearings 8, 9 are held fixedly in the respective end face cover 4, 6 and in particular arranged integrated therein. The two rotary bearings 8, 9 are in particular respectively arranged concentrically in relation to the housing longitudinal axis 5 and in particular concentrically with one another on the housing 2.

The substantial functional components of the electric motor 1 are arranged in the housing 2. A motor shaft 10 is arranged in the housing 2 and is mounted in the two rotary bearings 8, 9 so as to rotate with respect to its axis of rotation 11.

A commutator 12 and a rotor 13 are rigidly connected to the motor shaft 10. The commutator 12 is arranged on the drive-side end of the motor shaft 10 adjacent to the end face cover 6. The rotor 13 is arranged in the axial direction on the motor shaft 10 between the commutator 12 and the integrally formed end face cover 4.

The rotary bearing 8, which is arranged in the integrally formed end face cover 4, is in particular installed axially preloaded. For this purpose, the end face cover 4 has an integrally formed collar 14, which serves as an axial support for the rotary bearing 8. A flanged annular collar 15 serves as the axial stop for the collar 14. The rotary bearing 8 is axially pressed against the annular collar 15 by means of a sleeve 16. The sleeve 16 is fixedly held on the motor shaft 10. A first, internal thrust washer 17 is arranged in the axial direction between the sleeve 16 and the rotary bearing 8. A spring element in the form of a spring washer 19 is arranged in a corresponding end face recess 18 of the rotary bearing 8 on an opposite end face of the rotary bearing 8. The spring element 19 is axially held in the end face recess 18 by means of a second thrust washer 20.

A torque transmission element 22 in the form of a pinion is arranged on the output-side end 21 of the motor shaft 10 and is in particular rigidly connected to the motor shaft 10. The torque transmission element 22 is used to transmit the torque of a rotary movement of the electric motor 1 to a gear unit (not shown) and/or a spindle drive.

The structure and function of the spring element 19 is explained in more detail below with reference to FIGS. 2 and 3.

The spring washer is a plastic washer made in particular from PEEK, and manufactured in one piece. The spring washer has in particular a washer thickness which is between 0.2 mm and 0.4 mm, in particular between 0.25 mm and 0.35 mm and in particular 0.3 mm. The spring washer has a circular outer contour 23 which defines an outer contour centre point M_{A}. The outer contour 23 can also be non-circular, in particular polygonal, in particular square.

The spring washer further has an inner contour 24, which is substantially circular according to the exemplary embodiment shown. The circular shape of the inner contour 24 extends over a circumferential angle of at least 350°, in particular of at least 355° and in particular of at least 358°. The inner contour 24 defines an inner contour centre point M_{I}, which has a radial distance aᵣ from the outer contour centre point M_{A} in a plane oriented perpendicular to the axis of rotation 11. According to the exemplary embodiment shown, the radial distance aᵣ is 0.15 mm.

The spring washer is designed substantially as an annular disc with a circular outer contour 23 and circular inner contour 24, which are arranged eccentrically in relation to one another.

Adjacent to the inner contour 24, the spring washer has two spring arms 25, which are respectively integrally formed with the spring washer. The spring arms 25 respectively have an arm width _{A}, which is oriented in the radial direction with respect to the axis of rotation 11. The spring arms respectively have an arm length L_{A} oriented in the circumferential direction.

According to the exemplary embodiment shown, the spring arms 25 are facing one another and respectively have a free end 26. The two free ends 26 are arranged opposite one another in the circumferential direction. A radial opening from the inner contour to a relief recess 27 is formed between the two free ends 26.

The installation situation of the rotary bearing 8 with the spring element 19 is in particular shown in FIG. 3. The rotary bearing 8 is arranged in the housing 2 concentrically with respect to the housing longitudinal axis 5. The end face recess 18 is also formed on the rotary bearing 8 concentrically with respect to the housing longitudinal axis 5. The inner diameter of the end face recess 18 corresponds to the outer contour 23 of the spring element 19. The spring element 19 is form-fittingly held in the end face recess 18.

Due to the fact that the inner contour centre point M_{I} is arranged at a radial distance aᵣ from the outer contour centre point M_{A}, the inner contour 24 is arranged eccentrically with respect to the housing longitudinal axis 5 with an offset equal to the radial distance aᵣ. In particular, the eccentricity is arranged in such a way that the motor shaft 10 is pressed against the spring arms 25 in the radial direction with respect to the axis of rotation 11. The deflection of the spring arms 25 causes them to exert an elastic restoring force, i.e. a spring force, on the motor shaft 10. The spring force is oriented in the radial direction and in particular in the direction of the axis of rotation 11 of the motor shaft 10. This permanent spring force produces a defined load state for the motor shaft 10, in particular including for the event that a load-free state has been produced by coupling to a gear unit. The arrangement of the motor shaft 10 in the housing 2 is stabilised.

In a plane perpendicular to the axis of rotation 11, which corresponds to the drawing plane according to FIG. 2, the radial distance aᵣ defines a direction for the distance from the inner contour centre point M_{I} to the outer contour centre point M_{A}. It is particularly advantageous if the radial opening between the free ends 26 of the spring arms 25 is arranged along this direction. In particular, the outer contour centre point M_{A} is arranged at a smaller distance from the spring arms 25 than the inner contour centre point M_{I}. In particular, the inner contour 24 is arranged eccentrically with respect to the outer contour centre point M_{A}. The eccentricity is in particular such that the motor shaft 10 rests against the spring arms 25 and the spring arms 25 are elastically deflected thereby.

The spring force is adapted to the individual conditions in the electric motor 1 by virtue of the fact that the radial force is an elastic restoring force. Individual adaptation to tolerance deviations is thereby in particular possible. The electric motor 1 and in particular the spring element 19 are designed to be fault-tolerant.

The end face recess 18 has a depth, which extends along the housing longitudinal axis 5, which corresponds substantially to the thickness of the spring washer 19. The spring washer 19 is reliably arranged in the axial direction in the end face recess 18 and held by the second thrust washer 20. Unwanted axial movement of the spring washer 19 with respect to the rotary bearing 8 is prevented. In particular, the spring washer 19 is held in the end face recess 18 of the rotary bearing 8 with an axial press fit.

According to the exemplary embodiment shown, the spring force is 15 N per spring arm 25. The amount of spring force can be variably set by geo-metrically adjusting the spring arms 25. Essential factors for the spring force are the number of spring arms 25, the arm width, the arm length and in particular also the washer thickness as well as the material used to produce the washer.

Another exemplary embodiment of an electric motor is described below with reference to FIGS. 4 and 5. Structurally identical components bear the same reference numerals as in the preceding exemplary embodiment, the description of which is hereby incorporated by reference. Parts that are structurally different but have a similar function bear the same reference numerals with an a added after them.

A key difference with the electric motor 1a is that the spring element 19a is not arranged in an end face recess, but rather adjacent to an end surface 28 of the rotary bearing 8a. The spring element 19a rests in particular against the end face of the end surface 28. The end surface 28 is in particular planar and in particular continuous and in particular free of protrusions.

The spring element 19a has an outer diameter, which corresponds substantially to the outer diameter of the rotary bearing 8a. The outer diameter of the spring washer 19a and rotary bearing 8a corresponds substantially to the inner diameter of the collar 14.

The arrangement of the spring element 19a on the rotary bearing 8a is straight-forward. The spring element 19a is held axially along the axis of rotation 11 between the rotary bearing 8 and the annular collar 15 of the collar 14.

In terms of the spring element 19a itself, it should be noted that due to the larger outer diameter of the spring element 19a, both the radial width of the relief recesses 27 and the outer web 30 radially delimiting the relief recesses 27 are designed to be larger in the radial direction. The spring element 19a is mechanically robust sufficiently stable to absorb the mechanical vibrations. An opening angle w defined by the relief recesses is increased compared to the first exemplary embodiment and is at least 90°, in particular at least 120° and in particular 140°.

1. An electric motor comprising:
a tubular housing with end face covers,
respectively one rotary bearing held on the end face covers,
a motor shaft which has an axis of rotation and is mounted in the rotary bearings so as to rotate with respect to the axis of rotation,
a spring element for applying a spring force to the motor shaft, wherein the spring force has a force component in the radial direction with respect to the axis of rotation.

2. The electric motor according to claim 1, wherein the spring element is arranged on one of the rotary bearings.

3. The electric motor according to claim 1, wherein the spring element is arranged on the output side of the motor shaft.

4. The electric motor according to claim 1, wherein the spring element is designed as a spring washer.

5. The electric motor according to claim 4, wherein the spring washer is arranged on the rotary bearing in an end face recess.

6. The electric motor according to claim 4, wherein the spring washer is arranged adjacent to the rotary bearing and is arranged in particular on the end face of an end surface of the rotary bearing.

7. The electric motor according to claim 4, wherein the spring washer has an outer contour defining an outer contour centre point and an inner contour defining an inner contour centre point, wherein the outer contour centre point is arranged in a plane perpendicular to the axis of rotation at a radial distance from the inner contour centre point.

8. The electric motor according to claim 4, wherein the spring washer has at least one spring arm which is formed integrally with the spring washer.

9. The electric motor according claim 8, wherein the spring arm is adjacent to the inner contour

10. The electric motor according to claim 8, wherein a relief recess is arranged on a rear side of the spring arm opposite the inner contour.

11. The electric motor according to claim 8, wherein the spring washer has two spring arms which extend in a circumferential direction with respect to the axis of rotation and are arranged facing one another.

12. A spindle drive having the electric motor according to claim 1, having a spindle driven by the electric motor and in particular having a gear unit, which is arranged between the electric motor and the spindle in the torque transmission direction.

13. A flap arrangement having a housing, a flap arranged on the housing and the spindle drive according to claim 12 for adjusting the flap on the housing.
